(19) United States
(12) Patent Application Publication
(10) Pub. No.: US 2021/0109534 A1
(43) Pub. Date: Apr. 15, 2021

(54) METHOD OF NO DOUBLE-SPACE SPENDING FOR DRIVERLESS VEHICLES

(71) Applicant: Bryan B. Solstin, Mill Creek, WA (US)

(72) Inventor: Bryan B. Solstin, Mill Creek, WA (US)

(21) Appl. No.: 16/600,307

(22) Filed: Oct. 11, 2019

(51) Int. Cl. G05D 1/02; G05D 1/00; H04L 9/06; H04L 9/08

(52) U.S. Cl. CPC G05D 1/0214; G05D 1/0289; H04L 2209/38; H04L 9/0643; H04L 9/0819; G05D 1/0088

(57) ABSTRACT

Autonomous Vehicles (AVs) achieving a 99.999% vehicle safety remains a distant vision. Safety could be regressed to the principle requirement of no double-space spending. Bitcoin (BTC) is an example of no double spending of digital coin. The SRV system is a computerized method of no double-space spending of a path for driverless vehicles, and more particular, a highly divisible, 4D SRV title exchange without trusted third parties. Decentralized space reservation is more liquid, further optimizing transportation assets. The politics of resilience, congestion and maintenance is supplanted with algorithms known as rules. Blockchain Rules, transactions and emergent consensus enables resilience expected from decentralized systems. Most importantly, no double-space spending illuminates a path toward 99.999% AV safety.

### BACKGROUND

### Field of Invention

A computerized method of no double-space spending of a path for driverless vehicles, and more particular, a highly divisible, 4D SRV title exchange without trusted third parties.

### CPC 901/1

901 robots/1 mobile robot

### Description of the Related Art

Transportation remains challenged with resilience, congestion and maintenance. A computer glitch paralyzed London's Heathrow Airport for hours and computer glitches at London Heathrow and other airports keep happening. Decentralization is an opportunity to improve all the above issues.

Autonomous Vehicles (AVs) offer hope. SAE International Level 5, AVs can perform all driving functions under all conditions. The level 5 pursuit is a complex effort. Hardware and software must quickly recognize various objects in proximity in relation to the AV. Intersections with complex traffic lights remain a challenge. Mixing human operators with AVs on the same road is also affecting safety. Level 5 is achievable with current technology, however, achieving “99.999% safety remains a distant vision.

Nature is a lesson for decentralization and resilience. One ant is simple, has limited intelligence. However, by observing a few simple rules, an ant colony emerges and exhibits competitive, emergent brilliance. Due to their resilience ants may still be alive on this planet long after humans are extinct.

Bitcoin (BTC) is proving resilient with a decentralized system using a peer-to-peer network. BTC was the first to prevent digital, double-spending without a trusted third party. It is decentralized with no central server. A crypto proof replaces third-party trust. BTC is emergent, resilient and like a decentralized ant colony.

Improving resilience and safety will require new methods. Mixing AVs with human drivers will make the 99.999% safety objective, perhaps always 20 years away. Simplistic monorail architecture fails because of integration cost. Elon Musk's rapid-transit test tunnel, bored underground by The Boring Company demonstrates monorail thinking.

A decentralized, nodal method is more emergent, more mycelial. Nodes lay the groundwork for rapid mycelial growth, and consequently, could accelerate AV and Electric Vehicle (EV) growth. Driverless vehicles are naturally a good fit with electric propulsion.

Mycelium are found in soil and may form a colony that is too small to see or span thousands of hectors. Mycelium are tiny threads, connected at nodes, forming a vast decentralized network. The Mycelium sometimes connect with other plants, such as corn or Douglas Fir. Perhaps a decentralized system could be leveraged for building an ultra-reliable AV system.

Satoshi Nakamoto resolved the double-spend problem for digital currency. The SRV system, safety is regressed to no double-space spending. The SRV system is a computerized method of no double-space spending of a path for driverless vehicles, and more particular, a highly divisible, 4D SRV title exchange without trusted third parties. Decentralized space reservation is more liquid, further optimizing transportation assets. The politics of resilience, congestion and maintenance is supplanted with algorithms known as rules. Blockchain rules, transactions and emergent consensus enables resilience expected from decentralized systems. Most importantly, no double-space spending illuminates a path toward 99.999% AV safety.

### SUMMARY

Autonomous Vehicles (AVs) achieving a 99.999% vehicle safety remains a distant vision. Safety could be regressed to the principle requirement of no double-space spending. Bitcoin (BTC) is an example of no double spending of digital coin. The SRV system is a computerized method of no double-space spending of a path for driverless vehicles, and more particular, a highly divisible, 4D SRV title exchange without trusted third parties. Decentralized space reservation is more liquid, further optimizing transportation assets. The politics of resilience, congestion and maintenance is supplanted with algorithms known as rules. Blockchain rules, transactions and emergent consensus enables resilience expected from decentralized systems. Most importantly, no double-space spending illuminates a path toward 99.999% AV safety.

### BRIEF DESCRIPTION OF THE FIGURES

The components in the figures are not necessarily to scale, emphasis instead being placed upon illustrating the principles of the invention. In the figures, reference numerals designate corresponding parts throughout the different views.

FIG. 9 has three different time periods of AV on a Spline: Ingress, Coincidence and Egress. The AV or driverless vehicle has four different reference numbers indicating four distinct moments in time, in relation to the Ingress, Coincidence and Egress time periods. The interrelation of parallel splines enables an elegant SRV data structure, SRV creation and spline clash analysis and the same data structure is used for driverless vehicle navigation.

FIG. 1 The SRV System: gathering 4D information, transaction and an AV entering the SRV system.

FIG. 2 World Geodetic System (WGS84) comprises an ellipsoid and global coordinate system.

FIG. 3 SRV System, Terminal Round-Abouts and clocks indicating clockwise vehicle movement.

FIG. 4 WGS84 degree increments for giving a Terminal Round-About an average 0.55 km diameter.

FIG. 5 A Terminal Round-About Full Node (450) and a Terminal Round-About Module (400).

FIG. 6 The physical elements comprising the 2D Space Reservation Vector (2D-SRV).

FIG. 7 Positioning, Navigation and Timing (PNT) device with a driverless vehicle entering the SRV System.

FIG. 8 A 2D-SRV exiting a SRV System and entering a Terminal Round-About.

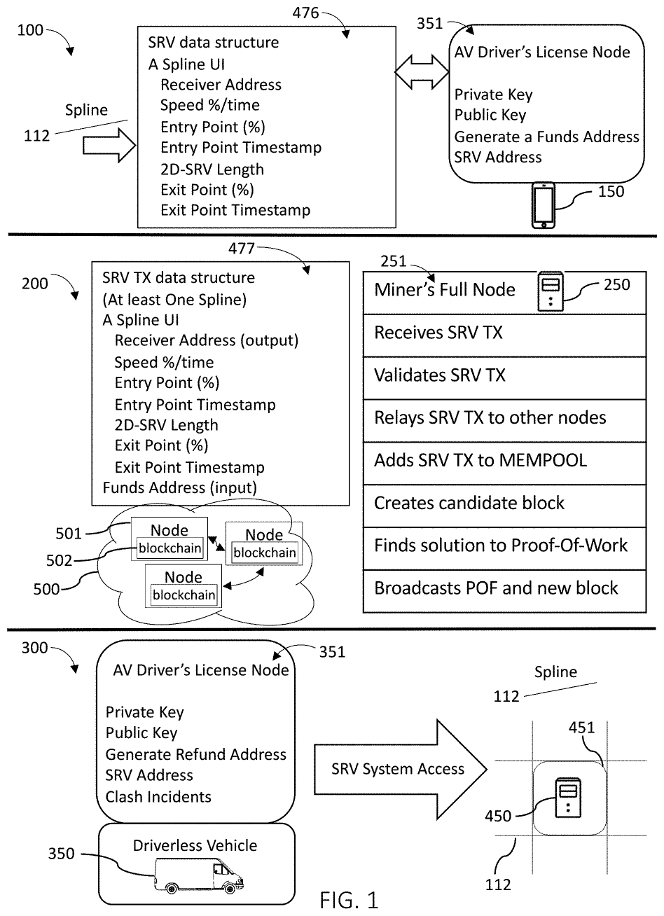

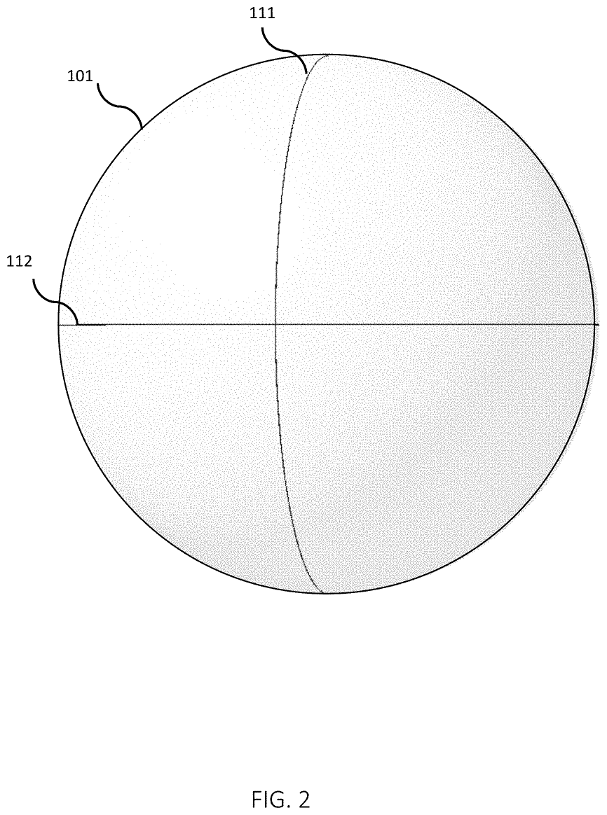

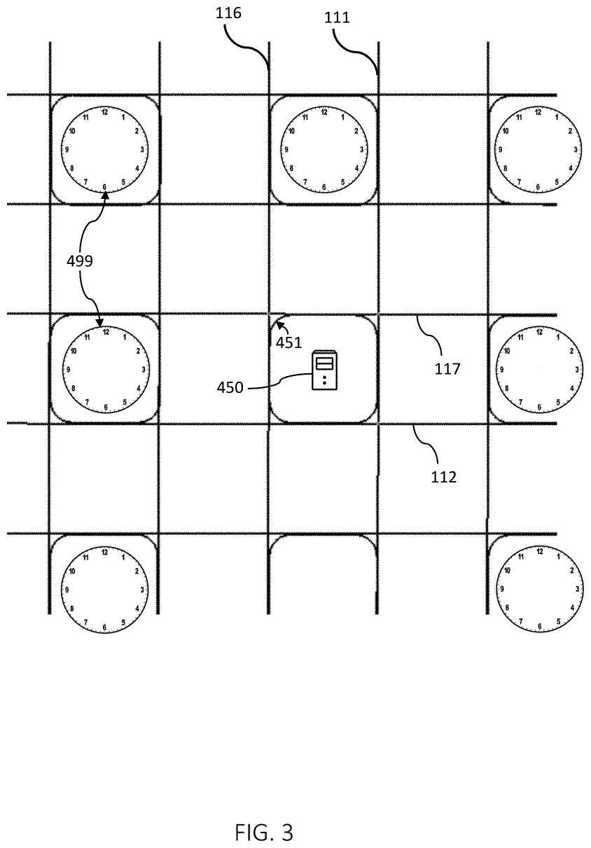

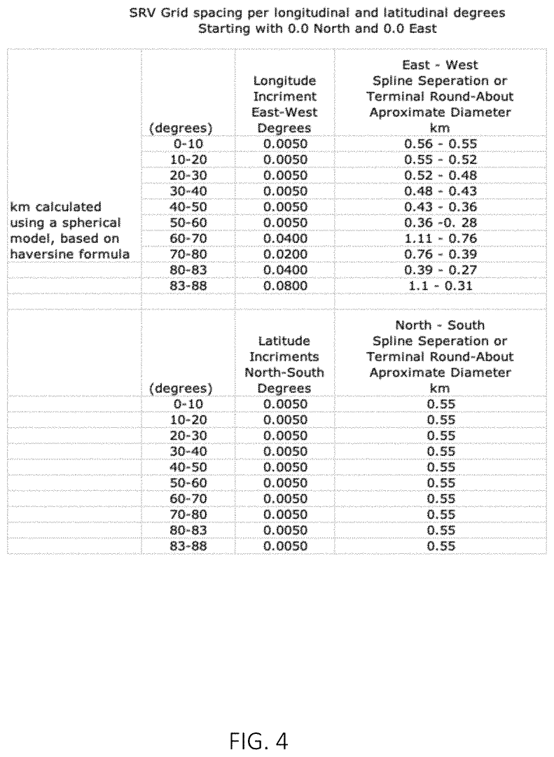

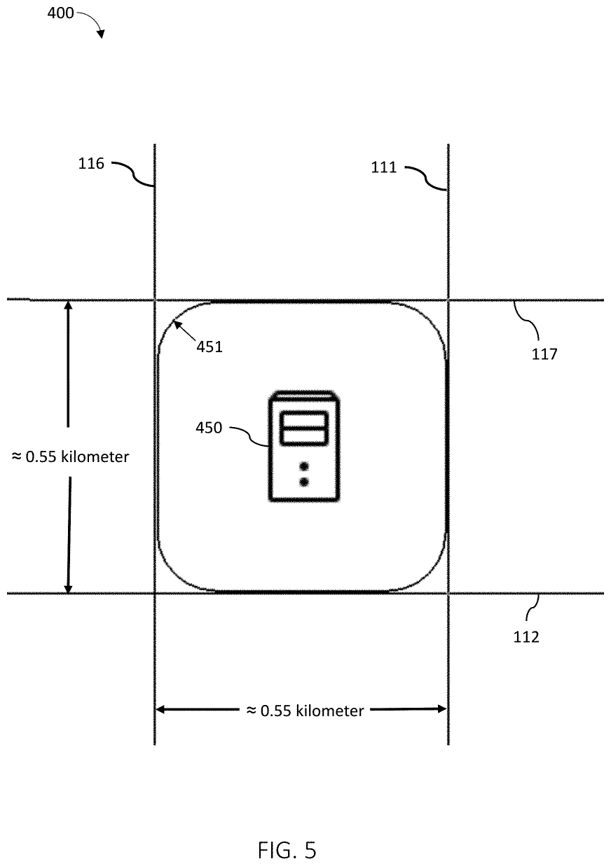

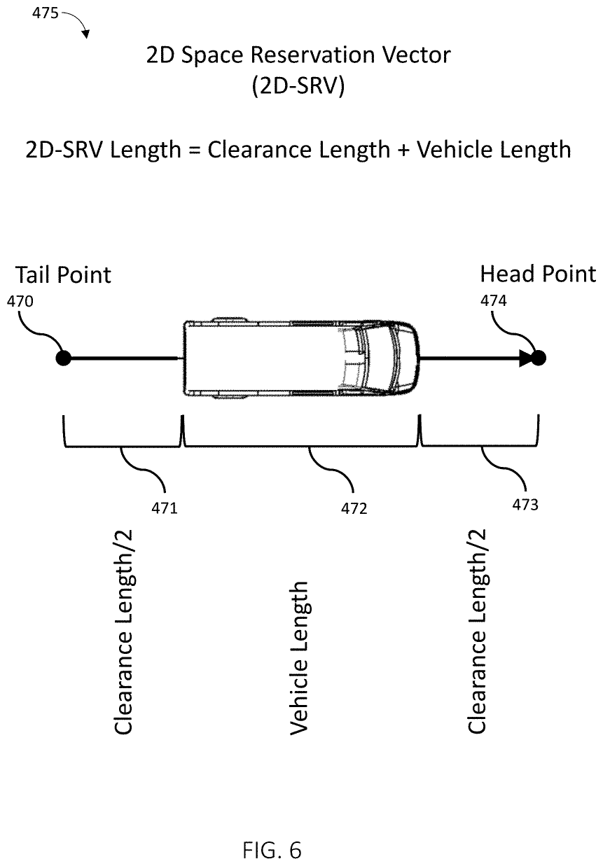

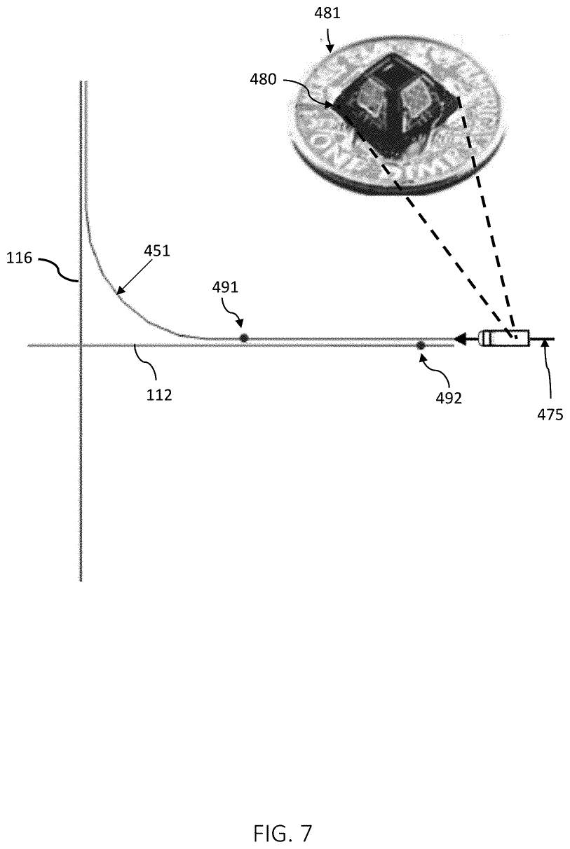

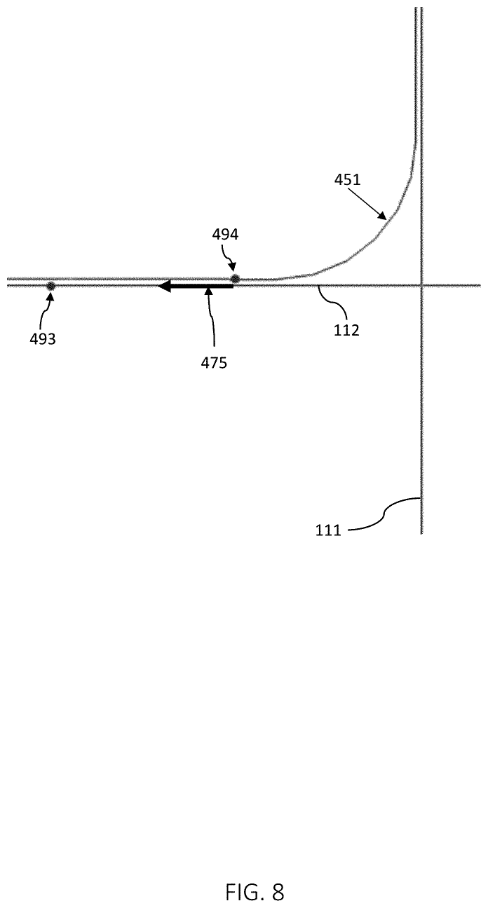

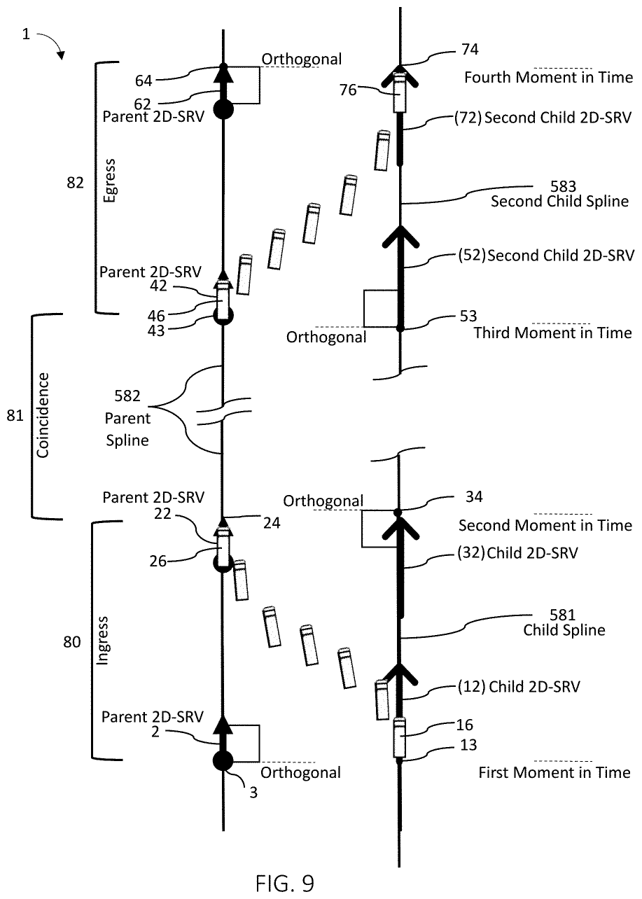

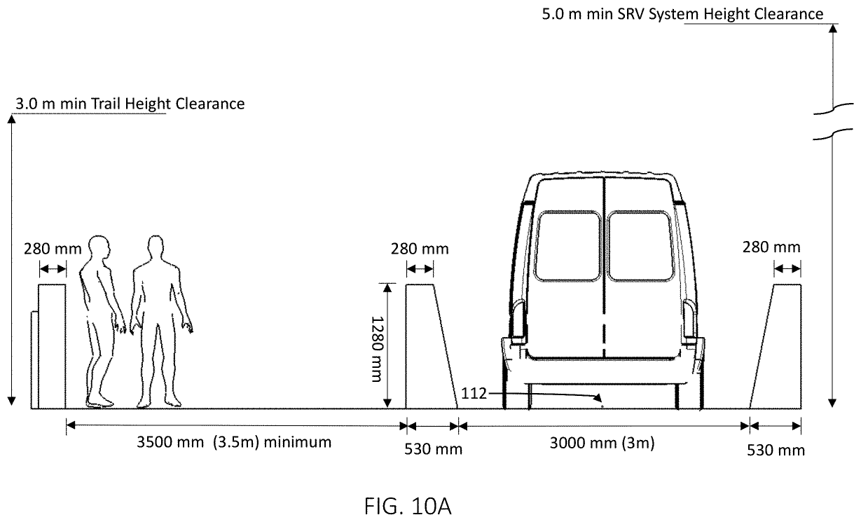

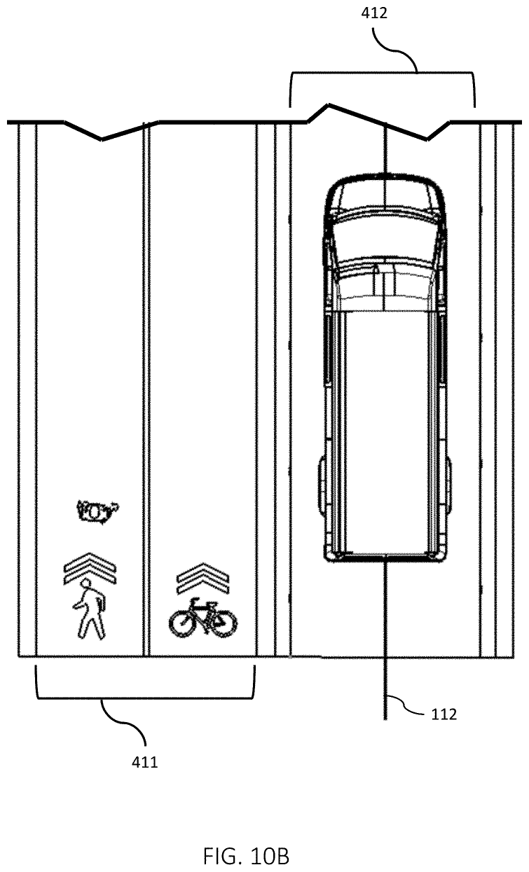

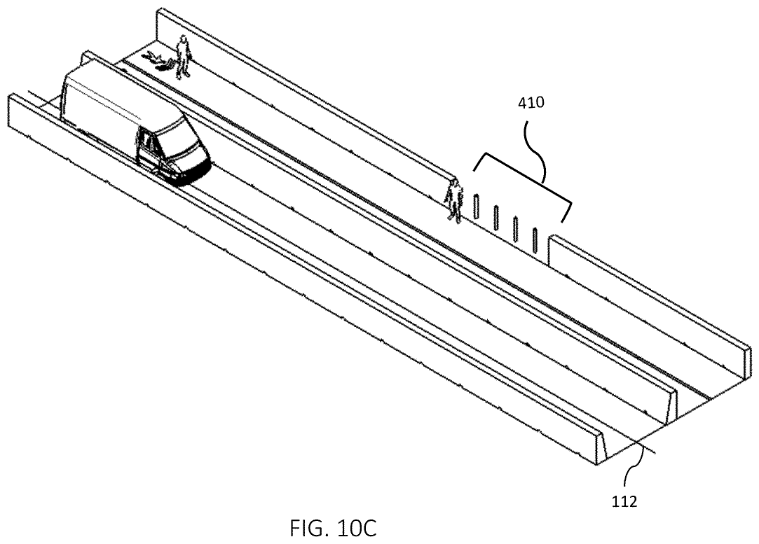

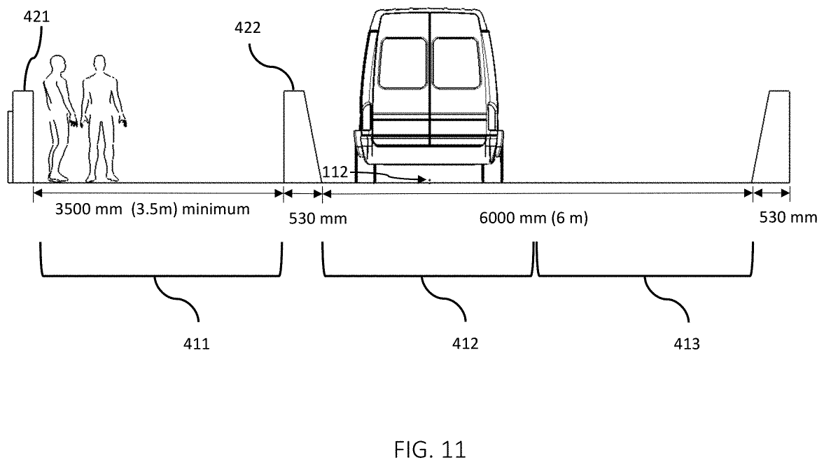

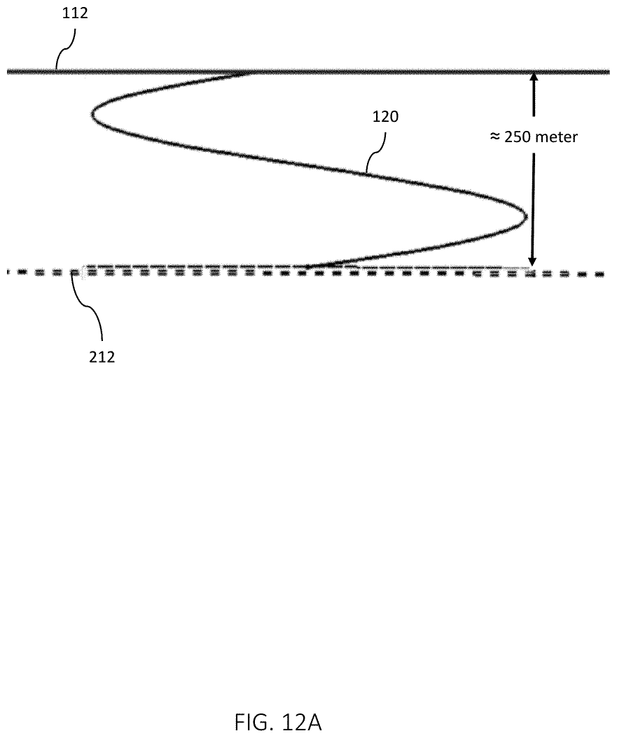

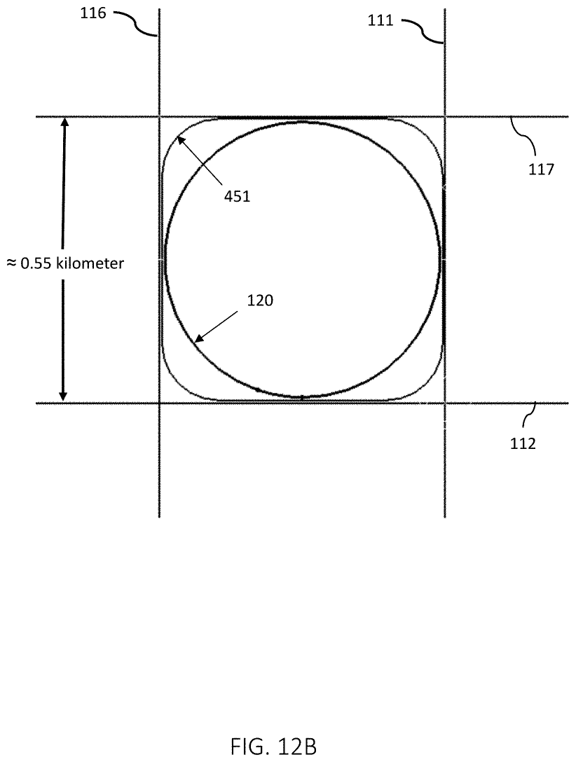

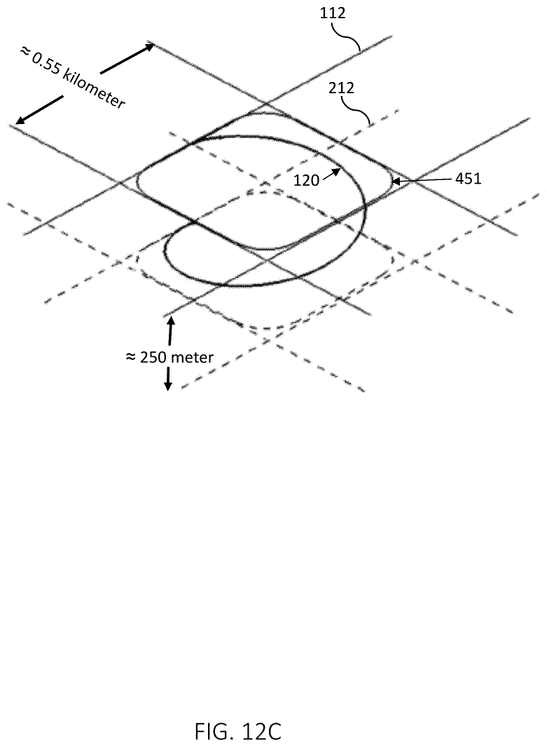

FIG. 9 Three different time periods of a Spline: Ingress, Coincidence and Egress.

FIG. 10A Represent a rear view of a Trail and SRV System.

FIG. 10B Represents a top view of a Trail (411) and SRV System (412).

FIG. 10C Represents an isometric of a Trail and SRV System.

FIG. 11 Represents the rear view of a Trail a SRV System and a Terminal Round-About (413).

FIG. 12A Side view of a Helix connecting an upper and a lower Terminal Round-About Modules (lower has dotted lines).

FIG. 12B Top view of a Helix connecting an upper and a lower Terminal Round-About Modules.

FIG. 12C Isometric View of a Helix connecting an upper and a lower Terminal Round-About Modules (lower has dotted lines)

### DETAILED DESCRIPTION

Autonomous Vehicles (AVs) achieving a 99.999% vehicle safety remains a distant vision. Safety could be regressed to the principle requirement of no double-space spending. Bitcoin (BTC) is an example of no double spending of digital coin. The SRV system is a computerized method of no double-space spending of a path for driverless vehicles, and more particular, a highly divisible, 4D SRV title exchange without trusted third parties. Decentralized space reservation is more liquid, further optimizing transportation assets. The politics of resilience, congestion and maintenance is supplanted with algorithms known as rules. Blockchain rules, transactions and emergent consensus enables resilience expected from decentralized systems. Most importantly, no double-space spending illuminates a path toward 99.999% AV safety.

The bitcoin (BTC) transaction with asymmetric encryption, cryptographic hash, Merkle tree, a protocol to enforce rules, proof of work to ensure consensus for the longest blockchain and doing the bitcoin transaction without a trusted third party solving the double spend problem for electronic money. The Space Reservation Vector (SRV) transaction (TX) solves the double space ownership of the digital 4D property. The 4^{th} dimension is time as the SRV move along a spline, without a trusted third party. No double-space spending with no trusted third party should enable rapid optimization of new commutes since SRVs can be treated as a commodity, highly divisible, and very liquid: easily bought, sold and resold. The terrestrial embodiment is disclosed in the following description. The SRV method for ultra-reliable AVs is also applicable for marine and air. As AVs, driverless vehicles and EVs become increasingly synonymous, the following description could be read as a proposal to accelerate EVs.

### Definitions

AV is an Autonomous Vehicle. Heretofore, AVs and driverless vehicles are synonymous. Driverless Vehicle is the same, but in the SRV context, the driverless vehicle is robot when it is following a spline. AV, recognizing proximity of various objects for SAE Level 5 is a backup method on the SRV system and AV also provide a last kilometer solution, from the SRV System to a final destination.

AV Driver's License Node (351) is an app or hardware device used to send or receive SRVs. The node is used to validate transactions and the integrity of the blockchain, generate a SRV address where currency is available, generate a SRV address where currency is received. Each Bitcoin address and SRV address is an asymmetric cryptographic funds address and has a corresponding private key that allows the AV Driver's License Node owner to spend the currency by creating a digital signature. Each SRV has a corresponding private key that allows the AV Driver's License Node owner to prove ownership of the SRV and enable the owner of the SRV navigate the corresponding spline. Owners include people, AVs, organizations, animals, payloads and Terminal Round-Abouts.

Clash Incident occurs when a driverless vehicle impinges or penetrates and excessive amount of clearance within the 2D SRV. Clearance is part of the 2D-SRV: vehicle length plus the clearance length comprises the vector length. For example, a clearance rule would trigger an incident when 50% of the clearance is penetrated by the driverless vehicle. The PNT calibrates with transformations the Head Point of the 2D-SRV. Points can be transformed to different locations along the 2D-SRV. The PNT can also be the sensor for triggering road flatness and other quality incidents.

Cloud of Nodes (500) is a system of nodes and each full node has decentralized software used to validate transactions and validate blockchain. Miner's Full Node (251) and AV Driver's License Node (351) are also part of the Cloud of Nodes (500). Each is a full node and each has a Memory Storage Medium, a Receiver to receive data and a Transmitter to broadcast. Nodes network over the internet. Every point of centralization is a point of weakness. Nodes should also network over cell tower RF, mesh networking, satellite, microwave, close proximity wireless networking, even ham radio for dire circumstances and other methods of network communication. The Cloud of Nodes is a resilient way for people, AVs, payloads and Terminal Round-Abouts to communicate and exchange data with little risk of messages being read by unwanted eyes. For AV entry and SRV owner verification, Terminal Round-Abouts could exchange data between fixed and mobile devices using a close proximity wireless networking.

Coincident. In geometry, two points are called coincident, or they have coincidence, when they are actually the same point as each other. A reliable method for a point to be coincident with a spline is to derive the point from the spline by simply defining a point by a singular spline's percentage. For example. 23.0809% of Spline UI.

Consensus Rules are the block validation rules that full nodes follow to stay in consensus with other nodes.

Exit Point, See Exit Point Timestamp

Exit Point Timestamp encodes a UTC timestamp and is associated with the exit point. The Exit Point is a location on the Spline where the SRV. The driverless vehicle shall not clash with the Exit Point. The driverless vehicle shall fully Egress from the Spline at the time of the exit point timestamp. The Exit Point is derived from the Spline and is therefore is an attribute of the Spline.

Funds Address is an SRV address having a corresponding private key that allows a participant to spend the SRV by creating a digital signature. Participants include people, AVs, organizations, animals, goods and Terminal Round-Abouts.

Full Node is software used to validate the transactions and the integrity of the blockchain. Each full node is a relay for the Cloud of Node, which is a mesh network between nodes.

Genesis block does not exist. The first block will be lost as SRVs no longer sends year-old blocks with the blockchain.

Implicit 2d-srv length can be derived from two adjacent splines and both spline's attributes: the Entry Point, the Entry Point Timestamp, the Exit Point, the Exit Point Timestamp.

Mempool is a memory pool or transaction pool where unconfirmed transactions wait to be added to a candidate block. Almost every node maintains a mempool. Incoming transactions are validated, added to the node's mempool and relayed to neighboring nodes.

Entry Point, See Entry Point Timestamp

Entry Point Timestamp encodes UTC timestamp. The Entry Point is a location on the Spline. An Orthogonal Entry Point projected from the Entry Point. FIG. 9 explains further the structural relationships.

Miner's Full Node is software used to validate the transactions and the integrity of the blockchain, and creates candidate block, finds solution to Proof-Of-Work, broadcasts POF and new block.

Owner: Splines are highly divisible. Consequently, an SRV is highly divisible. For example, a spline begins and 0.000000% and end at 90.00000%. The 0 to 90 does not imply that an SRV system spline needs to correlate with latitude, but it opens the opportunity to do so. Any percentage can be a highly accurate Entry Point along the spline. Likewise, with an Exit Point. In combination, the two points fully defines 3D spline ownership. With timestamps, a 4-dimensional title is defined, for the purpose of ownership and driverless vehicle navigation. A digital 4D title is liquid and can be divided and rejoined many times during route optimization.

Parent Spline and Child Spline. Parent Splines are relatively faster than a child spline. If the speeds are the same. The spline to the left is the parent spline. The Terminal Round-About Spline is slower than the SRV System Spline and therefore the Terminal Round-About Spline is a child spline. All Parent Spline attributes in the SRV dataset can described with Parent suffix; such as, the Parent 2D-SRV. The orthogonal entry point is derived from a parent spline, parent entry point, child spline and shares the parent entry point timestamp. It will align with the Child Spline Entry Point minus the Child 2D-SRV. This structure accelerates spline clash analysis for SRV optimization.

Point is a 3D point. A spline is created using the WGS84 model. The Entry Point and Exit Point is created on a spline by a simple percentage between 0.00000% and 90.00000%, The 3D point definition is highly accurate and is conducive to a 4D definition; meaning, the point movement or speed is time dependent (percentage divided by time). The precision of driverless vehicle navigation will benefit. Going 0 to 90, instead of 0 to 100, will help WGS84 integration, but it is not required for an SRV System spline to correlate WGS84 coordinate system, even though this address system continues to grow in dominance.

PNT is a Position, Navigation and Timing device. Micro-PNT devices are micro-electromechanical devices that were developed by the Defense Advanced Research Projects Agency (DARPA) and include precise chip-scale gyroscopes, clocks and completely integrated timing and inertial measurement devices all on a single chip. PNTs continue to advance in miniaturization, accuracy and reduced cost enabling the production of highly accurate and relatively inexpensive micro-PNT devices.

Public Key is one of the two keys needed for asymmetric encryption. Data encrypted with the private key must be decrypted with the public key and vice versa. The public key is easily derived from the private key, but the reverse is nearly impossible.

Spline definition is a special function defined piecewise by polynomials. This definition is the same with the SRV system. In other words, a spline is a plurality of tangent polynomials. For the lay person, two tangent lines have a very smooth connection. or two curved lines have very smooth connection or line and a curved-line have a very smooth connection. The term spline comes from the flexible spline devices used by shipbuilders and draftsmen to draw smooth shapes. With the SRV system, a spline is a smooth, three-dimensional line. The line having a plurality of lines and curves needed for curve-fitting. With the SRV System, an SRV System Spline will also have a speed attribute: % per hour.

Spline-to-Spline clash analysis is a 4D-Spline-to-4D-Spline-clash-analysis. Spline Clash Analysis each delimited spline of an SRV limited by an Entry Point, Entry Point Timestamp, Exit Point, Exit Point Timestamp, (and optional 2D-SRV) and compare to the blockchain delimited splines. Delimited is adding fixed boundaries or limits to the SRV System Spline identified as a spline UI. Spline-to-Spline clash analysis, or clearance analysis performs the same analysis using two delimited splines representing the space owned by two vehicles. No double space spending is the absolute rule; therefore, the owned splines being compared are delimited from the same SRV system spline but limited with Entry Point, Entry Point Timestamp, Exit Point, Exit Point Timestamp, 2D-SRV. A spline clash analysis is more specifically is to ensure no delimited spline overlaps another delimited spline. If they overlap, the logic is TRUE and that's not good. The proposed SRV is rejected.

Spline UI refers to a spline unique identifier. After a revision, the spline will receive a another globally unique identifier or Spline UI. Spline refers to a wide class of functions that are used in applications requiring data interpolation and/or smoothing. Within the SRV context, and at the time of this disclosure, a B-Spline is the preferred mathematical spline. Other mathematical splines work fine. Consistency for future integration work is recommended, but not necessary. The Spline function is a combination of flexible bands that passes through the number of points that are called control points and creates smooth curves. These functions enable the creation and management of complex shapes and surfaces using several points. Spline function and Bezier functions are applied extensively in shape optimization methods, which includes curve fitting a Spline to infinitesimally thin line or intersect generated from an intersect of a half spheroid and a plane. The Spline is an ideal driverless vehicle path. The Spline can also be fitted or smoothed into a Spline revision, fit to Earth's topology or a subterranean tunnel. A spline is fitted or smoothed into a spline revision. The Spline can be fitted and smoothed to Earth's topology, a subterranean tunnel or other road configurations. With the SRV System, an SRV System Spline will also have a speed attribute: % per hour.

SRV (476) is a delimited 4D spline and also a list of 4D Splines.

Time dependent spline. A 4D spline defined on SRV System spline. See 4D Spline. The Entry Point beginning with a Tail Point (470) and ending the Exit Point ending with a Head Point (474) is not only novel, it is elegant. With a spline speed, the definition of the 2D-SRV (475), the space of the driverless vehicle, is implicit form the element described in this paragraph. The driverless vehicle must simply stay within the moving boundary (time-dependent spline) and SRV transactions (TX)s are simplified.

SRV Blockchain is a decentralized ledger and title system of highly divisible splines enabling 4D, SRV ownership and enabling driverless vehicle navigation. The 2D-SRV must fit within the full path of the SRV's implicit 2D-SRV. FIG. 9 illustrates the entry orthogonal point, exit orthogonal point and the implicit 2D-SRV.

SRV Core is the source code for SRV's reference full node software. Bitcoin Core source code is available at Github.com. The bitcoin transactions need to be modified to the SRV TX data structure. Adding additional elements, as described in this specification, to the Bitcoin transaction is straight forward due to Satoshi Nakamoto versatile, unstructured network. Nodes work all at once with little coordination. Just as bitcoin is highly divisible, the SRV is highly divisible. SRV splines can be rejoined with other splines. SRV Core developers will modify rules, terminal fees and SRV system spline fees, which are decentralized scripts. Developers depoliticize maintenance with simple rules. Lawmakers are to law, as SRV Core developers are to rules. Rules and incentives can be enforced with the blockchain consensus mechanism. Miners build consensus when they spend their Proof of Work. With the BTC network and SRV network, nodes can leave and rejoin the network at will. A Bitcoin (BTC) wallet will have to be converted to AV Driver's License Node. Both networks, with the use of miners and proof work, clarifies which transactions a node saw first. Even at exact equal times the longest blockchain resolves the conflict. To avoid Bitcoin Cash (Bcash) drama or sibling revelry, no more than 9 voting developers represent the constituent terminals. 3 voting developers associated per breakdown described below.

Privacy for shared AVs needs to be protected on the SRV system. The idea that you must give up your SRV system privacy for security is a myth. A business Terminal Round-About may control payload entry. Likewise, a municipal Terminal Round-About may control payload entry.

SRV Driver's License Node is an app or hardware device enabling participants to receive or send SRV. The software contains a list of SRV addresses and their corresponding private keys.

SRV TX is an SRV transaction. The transaction is confirmed with a new block on the SRB blockchain, just as a BTC transaction is confirmed with a new block on the BTC blockchain.

SRV System primarily comprises latitude and longitude splines. An objective, but not requirement, is for the latitude Splines to overpass the longitude spline, to make integration more consistent. Copy and paste is easier, with the intent of reducing cost. For ease of remembrance, the latitude Splines are outward for climbing a globe, like rungs of a ladder. A Computer Aided Design (CAD) method will be discussed later. Consistency is important. Consistency with transformations is very important; otherwise, accuracy will be lost.

Rules are validated for each block. The new block contains SRV TXs. A transaction (TX) will add the address of each spline of the terminal to terminal route to the SRV, and the SRVs will be added to the AV Driver's License Node and spendable outputs goes to the UTXO.

SRV Protocol is similar to Bitcoin (BTC) protocol. An established procedure that miners and clients must follow.

Terminal Address is an address where currency is received. Each address has a corresponding private key that allows the terminal owner to spend the currency by creating a digital signature. Bitcoin (BTC) and SRV use an asymmetric cryptography with a public and private key pair as a mechanism to receive and authorize spending.

Terminal Round-About (451) is a substantially circular Spline. It is an on-ramp, off-ramp to the SRV system, and is connected as circle enabling non-stop left turns, non-stop right turns, and non-stop U-turns with minimal structure. Terminal Round-About availability is limited to a year in advance to reduce the size of the blockchain.

Terminal Round-About Module (400) includes the Terminal Round-About Spline and Terminal Round-About physical road, Terminal Round-About Full Node (450) and the physical SRV System shown in FIG. 5. The SRV System Splines and Initial Spline Offerings (ISO)s are managed by the SRV Core. ISO With SRV Core, UTC uses the Greenwich Mean Time (GMT) Zone. Just like bitcoin, the SRV is highly divisible. What is initially offered will be broken-down into many SRVs, rejoined and optimized even further.

UTXO is the unspent transaction outputs and is like the Bitcoin UTXO but incorporates the SRV data structure. Full nodes track all available and spendable outputs with the UTXO.

SRV TX is a 4D Space Reservation Transaction. 4D is 4 Dimensions. Time is the 4^{th} Dimension. The spline is sometimes curved, meaning 3 dimensions and the movement of the 2D Space Reservation Vector (2D-SRV) according to time is the fourth dimension. In other words, time is the 4^{th} dimension. SRV TX is a data structure that encodes the list of splines transferable between participants on the SRV system. Participants include people, AVs, organizations, animals, goods, recyclables, payloads and Terminal Round-Abouts.

4D Spline is a SRV System Spline or other static spline with additional time-dependent boundaries or limits. Delimited with a, Entry Point, Entry Point Timestamp, Exit Point, and Exit Point Timestamp, (2D-SRV is Optional). Orthogonal Points are derived between splines when a driverless vehicle changes from a spline to another adjacent spline. Also, it is important to understand, SRV splines are not static. It's moving with the 2D-SRV and ensures a spline-to-spline clash analysis will keep vehicles clear of each other and not have physical clash. To understand, think a new spline every second, or even more often in close proximity scenarios. This may seem complicated. It's not intuitive, there are a lot of splines. However, indexing all the splines according to time, spline percent beginning and spline percent ending, makes clash detection computationally efficient for the purpose of ensuring no double-space spending. The 4D spline is an important structure for spline-to-spline clash analysis. Calculus methods simplifies clash analysis even more. The 4D Spline or time dependent spline enables fast spline-to-spline clash analysis. The SRV is a list of 4D Splines.

Unlike Bitcoin (BTC), there is no Genesis Block in the SRV system. Initial Spline Offerings are available as early as one year before the commute. There are two reasons: help keep the blockchain small and help keep on-demand commutes more available. The blockchain can also be reduced 1 year after the itinerary exit. This is advantageous over Bitcoin (BTC) need to have traceability all the way back to the Genesis block.

There are other ways to reduce the SRV Blockchain in comparison to the Bitcoin (BTC) Blockchain. 2^{nd} layer network that operates on top of a blockchain; such as, Lighting Network. SRV carriers could run a platoon in one SRV TX. Multi-Modal blockchains could split blockchains between air, terrestrial and marine. Terrestrial could further breakdown the blockchains to another level in a Work Breakdown Structure (WBS), with a triopial: Afrabria, Eurasia and America. And continuing the previous developer core conversation and their breakdown, they could follow the blockchain breakdown.

With sizable growth, additional methods could further break the blockchains to smaller regions or add another level of the WBS. Optimization performance could further be managed by secondary networks; like the BTC Lighting Network but transact SRVs instead of bitcoins. And other methods will reduce blockchain congestion. New SRV blocks will be created faster than new BTC block every 10 minutes. SRV do not create coin. New SRV blocks will be created in seconds, not minutes.

Regardless of blockchain fracturing, SRV Protocol will enable secondary networks to integrate the list of 4D Spline addresses and integrate across different modes: terrestrial, air and marine. Itinerary, transaction and explicit robotic navigation instruction simultaneously compiled into elegant data structure referenced by private key and the addresses. When using the SRV, the AVs are following instructions as robotic vehicles. The AV capability is a secondary safety backup and a potential “last kilometer” method after leaving the SRV system.

Maintaining AV capability for the SRV system will add additional cost to the entry ramp and exit ramp which are part of the Terminal Round-About. Like human operators, AV lidar or AV cameras need additional ramp to recognize proximal objects and fit between them. The SRV doesn't. The SRV explicitly knows what part of the road, air or water it owns and moves accordingly. Regardless, Terminal Round-Abouts should be built using more expensive AV requirements, because the AV capability, as backup capability, helps move toward 99.999% safety. AVs will take more clearance between vehicles but can help empty the SRV system, as a secondary system.

Looking at FIG. 1, the method can be broken into three interrelated methods: Gathering 4D Information (100), Transaction (200) and An AV Entering a SRV System (300). Gathering the 4D information (100) is an iterative optimization process between an AV Driver's License Node, Terminal Round-Abouts, SRV System Splines and other splines. The AV Driver's License Node entity can be a Driverless Vehicle (350), or a person with a smartphone (150), AV Driver's License Node can be an AI enabled pallet or even a dog that can indicate a destination to the smartphone. Once a destination is selected, the AV Driver's License Node will build an optimal path. The optimization steps could occur again, if a perturbation were to occur, during the commute.

The SRV (476) will comprise at least one Spline:
Spline UI (Unique Identifier)
   Receiver Address,
   Speed %/time (attribute of a spline UI)
   Entry Point (%),
   Entry Point Timestamp,
   2D-SRV Length (optional at time of transaction)
   Exit Point (%), and
   Exit Point Timestamp.

Each listed Spline in the SRV data structure will have an Entry Point and an Exit Point. The Entry Point and Exit Point are derived from the Spline. Each SRV can be compared to a blockchain, but only needs to perform spline to spline clash analysis. And all the splines can be indexed. Spline to Spline clash analysis with no trusted third party. Knowing this, you will come to understand the elegance of FIG. 9, where a spline is further defined with points. Back to the FIG. 1 discussion.

Before gathering 4D information (100) is complete, a Receiver Address is added for each spline in the SRV data structure (476). For additional transaction privacy, the Spline's Owner may create a new Receiver Address for each transaction (TX). The AV Driver's License Node will reside on a smartphone (150). The same SRV can later be transacted to an AV having an AV Driver's License Node, and vice versa. After the list of Splines and related information is gathered, with authorization using a Private Key, the AV Driver's License Node will Generate a Funds Address, adds it to the SRV data structure and broadcasts the Transaction. Broadcasting completes the SRV data structure transformation to a srv tx (477). The next method steps enable a miner to write the SRV TX to the blockchain.

Continuing the flow in FIG. 1, the Transaction (200) begins when the AV Driver's License Node adds the funds address to the SRV and broadcasts the SRV TX (477) to the Cloud of Nodes (500). A Miner's Full Node (251) is on a sever (250) and will add the SRV transaction (TX) to the blockchain without a trusted third party. To ensure other miners accept his block, the Miner's Full Node will perform a spline clash analysis. The spline clash analysis ensures no space is double spent.

The SRV's Miner's Full Node and BTC's Miner's Full Nodes perform similar steps. Satoshi Nakamoto created an elegant transaction data structure that accommodates additional fields needed for the SRV TX data structure. At present, a person having ordinary programing skill can download Bitcoin (BTC) source code at the Github web site and modify bitcoin data structure into the SRV data structure as described in this specification. Rules will also have to modified. Satoshi Nakamoto solved the digital no double spend problem without a trusted third party. With the structures described herein, the method steps ensure no double-space spending of a path reservation for a driverless vehicle.

Continuing with the transaction (200) flow of FIG. 1, the Miner's Full Node is on a Miner's Full Node (251) is on a Server (250). The Miner's Full Node performs the following steps:

Receives SRV TX

Validates SRV TX

Relays SRV TX to other nodes

Adds SRV TX to MEMPOOL

Creates candidate block

Finds solution to Proof-Of-Work (POF)

Broadcasts POF and new block

The method step: Validates SRV TX is checking the Rules, which includes no double-space spending by performing a spline to spline clash analysis. No SRV, at a given moment, will overlap your space. No clash. No accidents.

Spline clash analysis uses spines you own. The 2D-Space-Reservation-Vector's Length (2D-SRV) Length, is used to identify what splines you need to own. The 2D-SRV is the distance from the Head Point to the Tail Point. Entry Points and Exit Points are not for passing over, unless the two splines are tangent. In that case, the to splines will be joined into one spline.

The Entry Point marks beginning of the Ingress and the Exit Point marks the end of the Egress. With or without an 2D-SRV, the simplicity and elegance of SRV TX still enables rapid spline to spline clash analysis with the other SRVs. No double-space spending.

Not checking the Rules will save money but risk losing the benefit of creating a POF is simply more costly to the Miner. Other Miners will reject his new block because they will check the Rules. Other miners will not waste their Proof of Work (POW) on an invalid blockchain. The longest valid chain proves no space is double spent. Even more succinctly, the longest chain proves no space is double spent. The latest block may have a clash. There could be a bad-acting miner, but multiple confirmations is proof: no space is double spent, and the bad-acting miner will never receive the reward for creating the bad block. New BTC blocks are created about every 10 minutes, ensuring the gradually release of bitcoin. SRV does not share the need to release coin and the difficulty will be less. 3 confirmations within 30 seconds should be enough to keep the system decentralized. Remaining decentralized is needed for honest consensus.

The miner accepts the first SRV TX received and rejects the second SRV TX that overlap space. Or the miner might pick the SRV TX providing the highest transaction fee, which is part of the Receiver Address, and consequently, rejecting the first received. In either case, miner's resolves clash, ensuring no digital space is double spent. And the space on the Splines, or SRV, can be bought and sold many times, optimizing precious recourses without third-party cost, third-party corruption; such as, carriers charging more for shorter flights. When each Spline is free market: the most cost effective, and convenient itinerary is likely.

Continuing with the flow in FIG. 1. The Terminal Round-About will have a Spline and a Terminal Round-About Full Node (450). The owner, which could be a municipality or business, makes the initial SRV offering. The SRV TX will transfer some fraction or all the of the spline to the new owner, which could be person, organization, AV, pallet, dog, or anything capable of authorizing a destination with an AV Driver's License Node.

An AV entering an SRV System (300) starts with a Driverless Vehicle (350) having an AV Driver's License Node and address of the SRV. Ownership of the SRV is by merit of the private key.

Terminal Round-About (451) may require Proof of Ownership of the SRV. For additional security, by exchanging data at an SRV System entry between fixed and mobile devices over short distances could use short-wavelength UHF radio waves and build a personal area network (PAN).

Before entering the Terminal Round-About, the AV can provide Proof of Ownership by constructing a single transaction which spends the SRV in the Unspent Transaction Output (UTXO) but adds an extra invalid input. By including one invalid input, the entire transaction is rendered invalid and would be rejected by the network if broadcast. However, the transaction is constructed in such a way that it can still be used as proof of the SRV ownership. The transaction data can then be shared with the Terminal Round-About Full Node (450) triggering access; such as, hydraulic bollards vertically dropping granting access from the driverless Terminal Round-About Spline, or a movable fence opens. A movable fence would help keep animals from getting into the SRV system, reducing roadkill and increasing AV safety.

An AV Entering an SRV System (300) should have a Refund Address populated. Spline funds are escrowed without trusted third person until the AV exits the SRV system. Delays will refund the cost of the entire SRV, and minus the cost of rerouting assuming the arrival is equal or less than original entry time or arrival time at the Terminal Round-About. Refunds also include impacts by lack of road quality, maintenance-wear due to turns, or the average power cost for exceeding grade guidelines, which are like grade guidelines for rail. These Rules are examples how quality design and quality maintenance is incentivized. Safety too, will naturally improve as Splines on the SRV System are designed and revised to reduce real costs of AV operation.

Spline (112) in FIG. 1 is involved in the three interrelated methods: Gathering 4D Information (100), Transaction (200) and an AV Entering a SRV System (300). The following figures will explain how Spline (111), Spline (112), and the derived Entry Points and Exit Points are created and used.

Turning to FIG. 2, The World Geodetic System or WGS84 (101) comprises an ellipsoid and global coordinate system. Three points define a mathematical plane. The 0.0 plane intersects with North and South Pole. The plane intersects with the ellipsoid and creates a line. 0.0 degrees from the datum plane is the “Meridian” line on the ellipsoid. Two Splines are fitted to the intersect line. 0.0 degrees at the equator and 90 degree going to the North Pole. The second Spline is curve fitted to the intersect line, 0.0 degrees at the equator and 90 degree going to the South Pole. Two tangential splines are represented FIG. 2: longitudinal Spline (111). A similar method was used for creating the latitudinal Spline (112) at 0.0 degrees, the equator.

Zooming in from FIG. 2 to FIG. 3, the meridian Spline (111) and equatorial Spline (112) are still visible and other Splines have been created. The clocks (499) show the clockwise motion of the traffic.

Terminal Round-About (451) is a Spline and the traffic travels clockwise in a circular fashion enabling SRV System right turns, SRV System left turns, SRV System U turns, SRV System on-ramp, SRV System off-ramp and SRV System buffering.

Spline (111) is a SRV System Spline and the traffic travels South.

Spline (112) is a SRV System Spline and the traffic travels West.

Spline (116) is a SRV System Spline and the traffic travels North.

Spline (117) is a SRV System Spline and the traffic travels East.

Turning from FIG. 3 to FIG. 4. The table is worksheet showing the degrees needed to create to SRV System Splines approximately 0.55 kilometers apart. Splines gradually narrow toward each other when moving North or South. When they get too close together, it is necessary to clip longitudinal splines to get back to the 0.55 kilometers objective, and done in pairs to ensure adjacent splines run in opposite directions and enables Terminal Round-Ab outs.

Based on FIG. 4 analysis, a 0.0050-degree increment is a good standard for spline separation for Terminal Round-Abouts. FIG. 5 represents the Splines and Node of one Terminal Round-About Modul (400). Splines are used as master geometry to build physical roads. The Splines are also used for deriving the Entry Point, Exit Point and providing precision driverless vehicle guidance. Miners do the spline to spline clash analysis according to the Rules. Full nodes too, validating the blockchain and validating prospective commutes.

The Terminal Round-About Modul (400) and Rules keep integration of new infrastructure low. In addition, with the Terminal Round-About Full Node (450) integrated with Terminal Round-About Modul (400). The Terminal Round-About Modules and Terminal Round-About Nodes combine the logical and physical node laying the groundwork for rapid mycelial growth. Mycelium are found in soil may form a colony that is too small to see or span thousands of hectors. Filaments interconnect and form a vast, decentralized network.

FIG. 6 represents a 2D Space Reservation Vector or 2D-SRV (475). During Coincidence, the 2D-SRV's Head Point (474) is substantially coincident with a Spline or slides along the Spline.

The 2D-SRV length consists of:

0.5 Clearance Length (471)+Vehicle Length (472)+0.5 Clearance Length (473)

Spline clash analysis uses the 2D-SRV Length, the distance from the Head Point (474) to the Tail Point (470). Clash analysis, with or without the 2D-SRV works because of the simplicity of SRV TX. The simplicity also enables rapid spline-to-spline clash analysis by the Miner's Full Node, AV Driver's License Node and other full nodes. An explicit 2D-SRV must be equal to or smaller than the implicit 2D-SRV derived by analysis of the SRV's list of splines. No double-space spending.

Turning to FIG. 7, the Positioning, Navigation and Timing (PNT) devices (480) are miniaturized Positioning, Navigation and Timing (PNT) circuits. A PNT devices (480) is shown in FIG. 7, disposed on the AV. It's preferable to install the PNT device where vibration is least. PNTs are micro-electromechanical devices that were developed by the Defense Advanced Research Projects Agency (DARPA) and include precise chip-scale gyroscopes, clocks and completely integrated timing and inertial measurement devices all on a single chip. Miniaturization of PNTs allow the production of highly accurate and relatively inexpensive micro-PNT devices. Micro-PNTs include three orthogonally oriented gyroscopes, three orthogonally oriented accelerometers and a time integration circuit, all disposed on a semiconductor chip that is smaller than a small coin (481), as shown in FIG. 7. The PNT (480) offers tremendous size, weight and power improvements over existing sensors. The PNT continues to improve. A recent accelerometer, for example, has graphene ribbons with suspended masses as transducers in an ultra-small nanoelectromechanical accelerometer.

To calibrate the SRV in relation Entry Point and related B Spline, Ultra-wideband (UWB), ultra-wide band and ultraband is a radio technology that can use a very low energy level for short-range, high-bandwidth communications over a large portion of the radio spectrum. UWB applications include precision triangulation with accuracy less than one centimeter. Once calibrated, a PNT without triangulation, navigates by communicating the change in position and change in orientation. The PNT is periodically calibrated. Constant connection to a GPS or road tracking system, is not required; likewise, LIDAR or cameras that autonomously recognize proximal “objects” are not needed but are a second layer of safety.

Those skilled in the art will recognize that other position determining devices, such as MEMs-type gyroscope, accelerometer and time circuit chips that are commercially available, can also be used for this function. If PNTs are not commercially available, any suitable position determining device that provides adequate positional and timing information and is of suitable size can be used.

Those of skill in the art will understand the principles of operation of PNT devices. As is well known, PNT gyroscopes and accelerometers track location by generating time-stamped coordinate points. A single point gives position of the PNT in three dimensions. Any two of such points make up elements of a line, which therefore defines an orientation (i.e. direction). It will also be apparent that speed is inherent from two time-stamped coordinate points, and the length is found along the Spline. Consequently, the PNT inherently provides data that tracks the speed and direction of the vehicle in real time.

Those of skilled in the art will also be aware that the PNT-generated points can be mathematically transformed, using a common transformation algorithm, from denoting the location of single PNT device (480) to denoting some other point, such as the 2D-SRV Head Point or other 2D-SRV points. In other words, the PNT location on the vehicle is not critical. Low vibration is good criteria for a PNT installation location on a driverless vehicle.

FIG. 7 represents a 2D-SRV (475) approaching a SRV System Spline (112). Before performing an s-pattern ramp maneuver from the Terminal Round-About (451) Spline to the SRV System Spline (112) the 2D-SRV must not clash with the Terminal Round-About's Exit Point (492). The 2D-SRV completes the s-pattern ramp maneuver after the SRV System Spline's Entry Point (492), when it passes it, but not over it. The orthogonal will be discussed in FIG. 9. The optimal pattern between parallel Splines resemble a partial “S” pattern.

FIG. 8 represents a 2D-SRV (475) approaching a Terminal Round-About Spline (451). Before performing an s-pattern ramp maneuver from the SRV System Spline (112) to the Terminal Round-About (451) Spline, the 2D-SRV must pass the Terminal Round-About's, Entry Point (494). The 2D-SRV does not perform s-pattern ramp maneuver before reaching the SRV System Spline's, Exit Point (493). The driverless vehicle performs the s-pattern ramp maneuver between two splines and their respective 2D-SRVs.

The s-pattern ramp maneuver method steps may also be used on perpendicular access. More distance would be needed with the Entry Point or Exit Point to enable proper acceleration or deceleration. If other parallel Splines are clashed when turning, an additional SRV Spline would need to be listed in the transaction (TX).

In FIG. 9 the driverless vehicle is not to scale. Reducing the driverless vehicle size helps illustrate the driverless vehicle, time periods, and points. Three different time periods (1) on the Parent Spline (582): Ingress (80), Coincidence (81) and Egress (82). The same Parent Points have orthogonal relationship to points on child splines. The driverless vehicle in FIG. 9 has four different reference numbers indicating four distinct moments in time, in relation to the Ingress, Coincidence and Egress time periods.

The Child Spline (581) in FIG. 9 is also a 1st Terminal Round-About Spline. The Parent Spline (582) is an SRV System Spline. Driverless Vehicles on the Parent Spline Move faster than Driverless Vehicles on the Child Spline. A 2nd Terminal Round-About Spline is represented as 2^{nd} Child Spline (583) and is a destination terminal. Between the two Child Splines, the driverless vehicle travels a longer distance on the faster Parent Spline. This will give motivation to reduce the 2D-SRV on the SRV Spline and use a longer 2D-SRV on the Child Splines. The added length will be added to the vehicle length, enabling slip for ramping. By purchasing larger spline, the vehicle length in a 2D-SRV will grow in length. The allows the driverless vehicle to move in the vehicle length like a slot without impacting clearance. The slot can have an imaginary tension like a “rubber band” in the 2D-SRV slot, before an on-ramp, and slack in the “rubber banded” slot before an off ramp.

On the Parent Spline (582), Ingress begins at the Entry Point (3). The Parent Spline's 2D-SRV's (2) Tail Point will be coincident with the Entry Point (3).

Perpendicularity is the relationship between two lines which meet at a right angle (90 degrees). Similar, orthogonal is a relation of two lines at right angles. With the SRV, the SRV Spline's Entry Point (3) projects orthogonally to the Child Spline (581). The result is an Orthogonal Entry Point (13). The Child Spline's 2D-SRV's Tail Point aligns with the Orthogonal Entry Point at the time of the Entry Point Timestamp. The Orthogonal Entry Point was derived from the Parent Entry Point. This is the beginning of the Ingress on the Parent Spline. At this first moment in time, the driverless vehicle (16) should have substantially used the slip in the larger 2D-SRV (12), like building tension in a “rubber band.” The slip is used as an on-ramp as the driverless vehicle moves toward the adjacent Parent Splines.

At the Second Moment in time, the Ingress ends when the Parent Spline's 2D-SRV's Head Point aligns with the Parent Orthogonal Exit Point (24) POEXIT_PT. The Parent Orthogonal Exit Point is projected 90 degrees from the Child Spline's Exit Point (34).

The Parent Spline's Coincidence (81) is simple. The Coincidence (81) begins at the Second Moment in Time. It begins when the Parent Spline Ingress ends and the Coincidence (81) ends when the Parent Spline's Egress begins.

At the third moment in time, the Parent Spline Egress (82) begins with Parent Orthogonal Entry Point (43) POENTRY_PT projected from the Second Child Spline's Entry Point (53). At this third moment in time, the Second Child Spline's 2D-SRV's (52) Tail Point aligns with the Second Child Spline's Entry Point (53). The Second Child Spline's Entry Point (53) is explicitly defined in the SRV TX. At the third moment in time, the SRV Spline's 2D-SRV's (42) Tail Point aligns with Parent Orthogonal Entry Point (43) POENTRY_PT. Also at the third moment in time, the Egress begins and the driverless vehicle (46) begins the s-curve pattern to off-ramp from the SRV System.

In FIG. 9, the Egress will be completed with describing the fourth moment in time. Let's begin with what is explicitly described in the SRV TX. The Parent Spline's (582) Exit Point (64) is explicitly defined in the SRV TX. At this fourth moment in time the Parent Spline also has an Exit Point Timestamp and correlates with current time. At the fourth moment in time, the Parent Spline's 2D-SRV (62)'s Head Point aligns with the Parent Spline's (582) Exit Point (64). At this fourth moment in time, the AV is fully Egressed from the Parent Spline (582). The “rubber band” will be tight from slowing down in the slot of the larger, Second Child Spline's 2D-SRV (72).

Let's define where the driverless vehicle (76) is at the fourth moment in time. At the completion of the Parent Spline Egress (582), the driverless vehicle (76) is substantially aligned with the Second Child Spline (583). The driverless vehicle (76) is aligned with Second Child Spline's 2D-SRV (72), and the driverless vehicle is within the slot, provided by the extra-long, 2D-SRV Vehicle Length. The Second Child Spline's (583) 2D-SRV's (76) Head Point is aligned with the Child Orthogonal Exit Point (74) COEXIT_PT.

All three splines would be listed in the SRV TX. During optimization, the 2D-SRV may or may not be populated in the SRV TX since it is inherent within the list of Splines, Entry Points, Exit Points. Entry Point Timestamp and Exit Point Timestamp.

Turning to FIG. 10A. The view represents a rear view of a Trail and SRV System. FIG. 10B represents a top view of the Trail (411) and the SRV System (412). FIG. 10C represents an isometric view of the Trail and the SRV System. The Spline (112) is for vehicle navigation and is also the master geometry for building the physical SRV System.

The SRV System Spline (112) may not lie on the WGS84 ellipsoid, a Spline revision may have been curve fitted and transformed to a terrestrial topology and smoothed. The unique Spline (112) revision could also be sub-terranean, similar to the France-England Channel Tunnel, or a floating bridge similar to Washington's SR 520 floating bridge, or similar to Norway's underwater bridge, or a simple bride. Spline elevation is flexible and has many options and may change with later spline revisions. Regardless, the longitudinal and latitudinal planes may seem expensive, but if there is a will there is a way and in the long run compliance will ease future integration costs, improve safety and lower operation costs.

Rules encourage adherence, including rail-like grades, and again, doing so reduces long-term integration cost, improves safety and reduces operation costs, and reduces maintenance cost; which should be refunded via SRV Core rules. The rules emphasize integratable nodes and splines; a contrast linear monorail logic. Pursuing decentralized transportation is logical nodal centric infrastructure and physical nodal centric infrastructure. Less cost integration nurtures safe, less-cost infrastructure for the smartest, most efficient cities.

The SRV System is thread like. Reduced cross-section reduces cost for tunnels, Chunnel's, floating bride, underwater brides, bridges and surface SRV System. The design also reduces environmental impact, less runoff. Only 3% of nations roads being SRV would carry more than 20% of the traffic due to vehicle compression and 24-7 operation of driverless vehicles moving goods and recyclables and with high integration with other modes of transportation.

Turning to the same model in FIG. 10B but looking at the top view of a Trail (411) and SRV System (412). The SRV System Spline (112) is a centerline and is master geometry for the physical road. The need for a trail could be questioned. However, it reduces the “not in my backyard” resistance. Secondly, the Trail provides a growing need for pedestrian, bicycling and small AVs. The Trail can be a corridor for utility, saving the SRV System surface from being repeatedly torn up and patched. EVs don't emit, but battery fires requires a contingency. With tunnels especially, the Trail provides emergency access and emergency passenger egress. In combination, not only does it improve multi-model transportation, but also improves SRV System safety.

If considering transportation, time spent per day, walking is our principle mode of transportation. Walking uses our largest group of muscles. If walking is not our principle mode of transportation, obesity is right around the corner. In the United State of America, pedestrian deaths are increasing disproportionately affecting lower-income, minority communities. The Trail will help reverse the obesity trend and pedestrian deaths.

The same model is in FIG. 10C but is an isometric view. Again, the SRV System and Trail are parallel. One more important note regarding the Trail, it provides access for migrating wildlife to cross the SRV System. Interstates, for example, negatively impact wildlife mobility. Perpendicular Access to The Trail (410) should be added just before and just after an overpass. Likewise, with an underpass. See FIG. 10C for the Perpendicular Access to The Trail (410). AI cameras, flash lighting, sound, pressurized air and cattle grids can help keep wildlife off of the SRV System and long Trail stretches.

Turning to FIG. 11, where wildlife access to the Trail is anticipated, the Continuous Barrier (422) between the Trail and SRV System should be taller. Regarding noise barriers, two shorter barriers can be more effective than one tall wall. AVs are quieter than vehicles with internal combustion engines, but tire noise is significant. Noise will be absorbed and reflected with the Continuous Barrier (422). However, some noise will go over the Continuous Barrier and some of that noise will diffract across the trail. The Trail Noise Wall (421) will absorb and reflect a significant portion of the diffracted noise. Neighbors on the Trail side of the SRV System will have a reduced environmental impact when compared to traditional roads, regarding noise, pedestrian safety, reduced roadkill incidents and a reduction in water runoff.

Continuing with FIG. 11 the model is different FIG. 10C. It includes a Terminal Round-About (413). The new model is clearly visible with rear view of a Trail (411) and a SRV System (412) and a Terminal Round-About (413). In this view, the driverless vehicle could potential exit from the SRV System to the adjacent and connected Terminal Round-About.

Horizontal nodes lay the basis for rapid mycelial SRV System growth and consequently would accelerate EV growth. FIG. 12A reveals a helix element for vertically connecting two Terminal Round-Abouts. This would increase the density of SRV System from 2D mesh, into thick mycelial mat. Building subterranean Terminal Round-About Modules make sense, not only for the increased buffering, AV charging, AV warehousing, and potential for rapid warehousing, but also, the helix method also enable future access to the communities above the higher elevation Terminal Round-About will be well positioned for future, low impact, horizontal growth.

FIG. 12A, FIG. 12B and FIG. 12C shows the same Helix (120) element. FIG. 12A is a side view. FIG. 12B is a top view and FIG. 12C is an isometric view. Each Terminal Round-About is a logical node and a physical node facilitating horizontal integration and facilitating vertical integration. In a subterranean embodiment some may say it looks expensive, but there are three factors negating this: First, surface streets are increasingly expensive due to the rise in real estate. Secondly, the cost of tunneling is dropping in price due to improved robotics and computational automation. Thirdly, the reduced cross-section of the SRV System is conducive for building a filamentous network; perhaps, ideal for going underground and enabling a networked-based model. With the following subterranean embodiment, the driverless vehicle will almost move as the crow flies, nonstop, without speed bumps, without traffic lights, and do so without weather events impacting the subterranean infrastructure. There are additional factors for cost effectiveness. Resilience and safety also reduce the overall cost.

FIG. 12A is a side view a Spline (112), and Terminal Round-About Module. The Helix (120) connects the two Terminal Round-About Modules. In this embodiment, the second Spline (212) represented as a dotted line and second Terminal Round-About Module, represented by the same dotted line, is about 250 meters below the first Spline. Again, the Helix (120) connects the two modules and more specifically, the Helix (120) connects Spline (112) to Spline (212). When setting up an itinerary, or list of Spline UIs in a srv tx, it could be possible for a Spline to be congested at one location. The driverless vehicle driving West on Spline (112) would have the option of taking a Helix (120) and drop down to the lower, subterranean Spline (212) and continue in the same direction.

FIG. 12B is a top view of the Helix (120). A section of Spline (111), a section of Spline (112), a section of Spline (116), a section of Spine (117) and the Terminal Round-About (451) in combination, these element represent the Terminal Round-About Module (400) previously discussed in FIG. 5. FIG. 12B, however, includes the Helix (120) connecting the lower Terminal Round-About Module.

FIG. 12C is the isometric view of the same Helix (120) previously shown in FIG. 12A and FIG. 12B. To fully appreciate FIG. 12C, it necessary to understand how it was made. Instead of doing a transformation from the WGS84 ellipsoid and curve fit it and smooth it to Earth's intricate, topology, a different method was used.

The first Terminal Round-About Module was modeled in an aerospace Computer Aided Design (CAD) software. I copied all the models and changed them into unique parts. Then reduced the radius of the axis and radius of the principle axis of the WGS84 ellipsoid by 250 meters. With a simple update, the change propagated to all the intersects and other mathematical relationships. All the splines on the ellipsoid dropped about 250 meters.

In FIG. 12C, this embodiment, the second Terminal Round-About Module has dotted lines. Again, the second Terminal Round-About Module is about 250 meters below the original Terminal Round-About Module. The Helix (120) represented as a solid line connects the two Terminal Round-About Modules. The original Terminal Round-About Module is represented as solid lines and the lower elevation Terminal Round-About Module is represented as dotted lines.

The Helix is not limited to one Helix per module as shown in FIG. 11C. Three additional Helix could easily be added connecting the two the Terminal Round-About Modules. Additional Helix could be used to turn left and turn right on the SRV System. As stated before, this embodiment empowers subterranean SRV System Splines to guide driverless vehicles almost as the crow flies. And for long-term planning, the Helix can also bring driverless vehicles back to the surface with the same kind of directional flexibility. Besides going underground, the SRV methods could also be used in aerospace and marine.

The description of the different illustrative examples has been presented for purposes of illustration and description and is not intended to be exhaustive or limited to the examples in the form disclosed. Many modifications and variations will be apparent to those of ordinary skill in the art. Further, different illustrative examples may provide different features as compared to other desirable examples. The example, or examples, selected are chosen and described in order to best explain the principles of the examples, the practical application, and to enable others of ordinary skill in the art to understand the disclosure for additional examples and modifications.

What is claimed is:

1. A computerized method gathering information for a time-dependent spline, comprising the steps of:
initiating an srv (476) to an av driver's license node (351) on a smartphone (150) having memory storage medium, receiver and transmitter;
writing to an the srv a spline ui of a spline;
writing to the srv an entry point coincident to the spline;
writing to the srv an entry point timestamp;
writing to the srv an exit point coincident to the spline; and
writing to the srv an exit point timestamp.

2. The computerized method gathering information for a time-dependent spline as recited in claim 1, further comprising the steps of:
writing to the srv a 2d-srv length.

3. The computerized method gathering information for a time-dependent spline as recited in claim 1, further comprising the steps of:
performing a spline-to-spline clash analysis between the srv (476) and a blockchain (502).

4. The computerized method gathering information for a time-dependent spline as recited in claim 3, comprising the steps of:
writing to the srv a receiver address of the spline limited by the entry point, the entry point timestamp, the exit point, and the exit point timestamp.

5. The computerized method gathering information for a time-dependent spline as recited in claim 4, further comprising the steps of:
accepting the srv with the smartphone (150);
generating a funds address with the av driver's license node and a private key; and
writing to the srv the funds address.

6. The computerized method gathering information for a time-dependent spline as recited in claim 1, further comprising the steps of:
broadcasting the srv (476) to a cloud of nodes (500) wherein a plurality of full nodes (501) each having memory storage medium, receiver and transmitter.

7. A computerized method of performing an srv transaction ensuring no double-space spending, comprising the steps of:
receiving an srv tx (477) to a miner's full node (251) on a sever (250) having memory storage medium, receiver, and transmitter;
relaying the srv tx to a full node (501) having memory storage medium, receiver, transmitter; and
relaying the srv tx to a cloud of nodes (500).

8. The computerized method of performing an srv transaction ensuring no double-space spending as recited in claim 7, further comprising the steps of:
rejecting the srv tx if a spline-to-spline clash analysis is true.

9. The computerized method of performing an srv transaction ensuring no double-space spending as recited in claim 7, further comprising the steps of:
performing a spline-to-spline clash analysis between the srv tx and a blockchain (502).
validating the srv tx if a spline-to-spline clash analysis is false.

10. The computerized method of performing an srv transaction ensuring no double-space spending as recited in claim 9, further comprising the steps of:
adding the srv tx to a mempool;
creating a new block;
generating a proof of work; and
broadcasting the new block and the proof of work to the cloud of nodes.

11. A computerized method of a driverless vehicle entering an srv system ensuring no double-space spending, comprising the steps of:
receiving an srv address to an av driver license node (351) on a driverless vehicle (250) having memory storage medium, receiver, and transmitter;
structurally coincide of the centerline of a driverless vehicle (350) to the vector of a child 2d-srv (12);
starting an ingress (80) when the utc time corresponds to a parent entry point timestamp of a parent spline (582), and when the tail point of a child 2d-srv's (12) substantially aligns with a parent orthogonal entry point (13);
accelerating the driverless vehicle to the speed of a parent spline (582); and
turning the driverless vehicle toward the parent spline.

12. The computerized method of a driverless vehicle entering an srv system ensuring no double-space spending, as recited in claim 11, further comprising the steps of:
generating a clash incident by the av driver's license node when the driverless vehicle is impinging more than 50% of a half clearance (473) of the child 2d-srv (12); and
broadcasting the clash incident from the av driver's license node to a cloud of nodes (500).

13. The computerized method of a driverless vehicle entering an srv system ensuring no double-space spending, as recited in claim 11, further comprising the steps of:
generating a clash incident by an av driver's license node when the driverless vehicle is impinging more than 50% of a half clearance (473) of a parent 2d-srv (22); and
broadcasting the clash incident from the av driver's license node to a cloud of nodes (500).

14. The computerized method of a driverless vehicle entering an srv system ensuring no double-space spending, as recited in claim 11, further comprising the steps of:
starting an egress (82);
entering a terminal round-about spline (451) from the outer circle of the terminal round-about; and
exiting the terminal round-about from the inside circle.

15. The computerized method of a driverless vehicle entering an srv system ensuring no double-space spending, as recited in claim 14, further comprising the steps of:
generating a receiver address by the av driver's license node and a private key;
generating a funds address (476) with a small valuation, less than one United States dollar, by a terminal round-about full node (450) having memory storage medium, receiver and transmitter;
broadcasting a srv tx (477) to a cloud of nodes (500) having memory storage medium, receiver and transmitter; and
verifying possession of the private key of the receiver address by waiting for a confirmation of a new block on a blockchain.

16. The computerized method of a driverless vehicle entering an srv system ensuring no double-space spending, as recited in claim 14, further comprising the steps of:
generating a public key using the av driver's license node and a private key;
encrypting a unique message with the public key;
sending the unique message to the av with av driver's license node;
decrypting the unique message with the av driver's license node and the private key; and
return the unique message as an ownership proof of the public key and the srv of the srv address.
